(19) United States
(12) Patent Application Publication
(10) Pub. No.: US 2026/0229535 A1
(43) Pub. Date: Aug. 6, 2026

(54) ELECTRODE FOR ALL-SOLID-STATE BATTERY, PRODUCTION METHOD THEREFOR, AND ALL-SOLID-STATE BATTERY

(71) Applicant: Maxell, Ltd,, Otokuni-gun, Kyoto (JP)

(72) Inventors: Haruki Kamizori, Otokuni-gun, Kyoto (JP); Seiji Ishizawa, Otokuni-gun, Kyoto (JP)

(73) Assignee: Maxell, Ltd,, Otokuni-gun, Kyoto (JP)

(21) Appl. No.: 19/149,671

(22) PCT Filed: Jan. 15, 2024
(86) PCT No.: PCT/JP2024/000724

§ 371 Date: Jul. 21, 2025

(30) Foreign Application Priority Data
Jan. 24, 2023 (JP) 2023-008819

(51) Int. Cl. H01M 4/62; H01M 4/02; H01M 4/04; H01M 4/131; H01M 10/0525

(52) U.S. Cl. CPC H01M 4/628; H01M 4/0433; H01M 4/131; H01M 10/0525; H01M 2004/021

(57) ABSTRACT

An electrode for an all-solid-state battery according to the present invention includes a molded body made of an electrode mixture, the electrode mixture containing a composite, which is obtained by compression molding of a mixture containing an active material and a solid electrolyte (A), and a solid electrolyte (B) that is the same as or different from the solid electrolyte (A), and the molded body made of the electrode mixture has a porosity of 10% or less and an area of more than 1.8 cm². An all-solid-state battery according to the present invention is an all-solid-state battery including a power generating element having a positive electrode, a negative electrode, and a solid electrolyte layer, and at least one of the positive electrode and the negative electrode is the electrode for an all-solid-state battery according to the present invention.

### TECHNICAL FIELD

The present invention relates to an electrode capable of constructing an all-solid-state battery having a low internal resistance, a method for producing the electrode, and an all-solid-state battery having a low internal resistance.

### BACKGROUND ART

In recent years, the development of portable electronic devices such as cellular phones and laptop personal computers, the practical use of electric vehicles, and the like have led to the need for compact and lightweight batteries that have a high capacity and a high energy density.

Currently, in lithium batteries, especially lithium-ion batteries, that can meet this demand, a lithium-containing composite oxide such as lithium cobalt oxide (LiCoO₂) or lithium nickel oxide (LiNiO₂) is used as a positive electrode active material, graphite or the like is used as a negative electrode active material, and an organic electrolyte solution containing an organic solvent and a lithium salt is used as a nonaqueous electrolyte.

Due to further development of devices that use lithium-ion batteries, there is a demand for lithium-ion batteries having an increased life-span, a higher capacity, and a higher energy density, and a high degree of reliability is also required for the lithium-ion batteries having an increased life-span, a higher capacity, and a higher energy density.

However, since an organic electrolyte solution used in a lithium-ion battery contains a flammable organic solvent, the organic electrolyte solution may abnormally generate heat when an abnormal situation such as a short circuit occurs in the battery. In recent years, as the energy density of lithium-ion batteries and the amount of organic solvent in the organic electrolyte solution have increased, there is growing need for reliability in lithium-ion batteries.

Under these circumstances, all-solid-state lithium batteries (all-solid-state batteries) not using organic solvents have also been considered. An all-solid-state lithium battery includes, instead of conventional organic solvent-based electrolytes, a molded body made of a solid electrolyte in which no organic solvents are used, and is highly reliable because there is no risk of the solid electrolyte abnormally generating heat. Therefore, in particular, there are great expectations for all-solid-state batteries in product areas in which high-capacity secondary batteries are required.

Also, all-solid-state batteries are very safe as well as being highly reliable and highly environmentally resistant, and have an increased life-span. Therefore, it is anticipated that all-solid-state batteries will become maintenance-free batteries that can continue to contribute to the development of society, as well as to safety and security. Providing all-solid-state batteries to society will contribute to reaching the following goals of the 17 Sustainable Development Goals (SDGs) established by the United Nations: Goal 3 (to ensure healthy lives and promote well-being for all people of all ages), Goal 7 (to ensure access for all people to affordable, reliable, sustainable and modern energy), Goal 11 (to achieve inclusive, safe, resilient and sustainable cities and human settlements), and Goal 12 (to ensure sustainable production and consumption patterns).

Incidentally, in all-solid-state batteries, an electrode having a molded body obtained by performing compression molding on a powdery electrode mixture containing an active material (positive electrode active material or negative electrode active material) and a solid electrolyte is usually used. In order to increase the capacity of such all-solid-state batteries, it is conceivable to increase the area of the electrodes and to increase the density of the molded body made of the electrode mixture. In this case, however, it is necessary to subject the molded body made of the electrode mixture to compression molding with a higher pressure than the pressure used in a conventional technique.

For example, in the case of a molded body that is made of an electrode mixture and has an area of up to about 1.8 cm² in a plan view, a molded body having a high density can be relatively easily obtained through molding at a pressure of about 800 to 2000 MPa (Patent Document 1 and the like). However, in order to obtain a molded body made of an electrode mixture layer and having a larger area but also having a density as close as possible to that with a small area of 1.8 cm² or less, it is necessary to use special equipment that enables pressing at higher pressure or the like, which leads to productivity issues. Furthermore, even if such special equipment is used, there is a limit to the area with which the electrode mixture layer can be formed with a high density. In addition, if the density of the molded body made of the electrode mixture is too small, there may arise problems such as an increase in the internal resistance of an electrode and the internal resistance of an all-solid-state battery using the electrode.

Although not intended to increase the density of a molded body made of the electrode mixture, Patent Document 2 proposes a method in which powder of sulfide-based inorganic solid electrolyte and powder of an electrode active material are subjected to compression molding, the molded result is then pulverized to produce granulated powder having an average particle size of 10 to 50 μm, and the granulated powder is then directly subjected to compression molding again to obtain the molded body made of the electrode mixture. According to Patent Document 2, the particle shape of the sulfide-based inorganic solid electrolyte is lost and a sea-island structure is formed, whereby the sulfide-based inorganic solid electrolyte and the electrode active material are bound together, improving the ion conduction paths at the interfaces between the two materials. Therefore, it is conceivable that the density of the molded body made of the electrode mixture may also be improved.

### PRIOR ART DOCUMENTS

### Patent Document

Patent Document 1: JP 2021-163582A (paragraphs [0078], [0079], and the like)

Patent Document 2: JP 2014-192061A (claims, paragraph and the like)

### DISCLOSURE OF INVENTION

### Problem to be Solved by the Invention

However, in the method described in Patent Document 2, even if the molding pressure during production of granulated powder is increased to produce granulated powder with a high density, the particle size of the granulated powder is as small as 50 μm or less. Thus, when pressure is again applied to the granulated powder as it is to mold a molded body made of the electrode mixture and having a large area, the porosity of the formed molded body is high, which makes it difficult to increase the density thereof. Therefore, even when the method described in Patent Document 2 is used, it is difficult to reduce the internal resistance of the molded body to a certain level or less.

In view of the above-described circumstances, the present invention was made to provide an electrode which is capable of constructing an all-solid-state battery having a low internal resistance, and a method for producing the electrode, and an all-solid-state battery having a low internal resistance.

### Means for Solving Problem

An electrode for an all-solid-state battery according to the present invention includes a molded body made of an electrode mixture, the electrode mixture containing a composite, which is obtained by compression molding of a mixture containing an active material and a solid electrolyte (A), and a solid electrolyte (B) that is the same as or different from the solid electrolyte (A), and the molded body made of the electrode mixture has a porosity of 10% or less and an area of more than 1.8 cm².

Further, a method for producing an electrode for an all-solid-state battery according to the present invention includes: a step (a) of forming the composite by applying a pressure of 800 MPa or more to a mixture 1 containing the active material and the solid electrolyte (A); and a step (b) of preparing a mixture 2 by mixing the composite and the solid electrolyte (B) that is the same as or different from the solid electrolyte (A); and a step (c) of forming the molded body made of the electrode mixture by forming a layer-like body made of the mixture 2 having a predetermined thickness and an area of more than 1.8 cm² and applying a predetermined pressure of less than 800 MPa to the layer-like body.

Further, an all-solid-state battery according to the present invention is formed by sealing, in an exterior body, a power generating element in which a positive electrode having a molded body made of a positive electrode mixture, a solid electrolyte layer, and a negative electrode having a molded body made of a negative electrode mixture are stacked, and at least one of the positive electrode and the negative electrode is the electrode for an all-solid-state battery according to the present invention.

### Effects of the Invention

According to the present invention, it is possible to provide an electrode which is capable of constructing an all-solid-state battery having a low internal resistance, a method for producing the electrode, and an all-solid-state battery having a low internal resistance.

### BRIEF DESCRIPTION OF DRAWINGS

FIG. 1 It is a schematic cross-sectional view showing an example of an all-solid-state battery of the present invention.

FIG. 2 It is a schematic cross-sectional view showing another example of the all-solid-state battery of the present invention.

### DESCRIPTION OF THE INVENTION

<Electrode for all-Solid-State Battery and Production Method Therefor>

An electrode for an all-solid-state battery of the present invention includes a molded body made of an electrode mixture, the electrode mixture containing an active material and a solid electrolyte, and is used as a positive electrode or a negative electrode of the all-solid-state battery. Examples of the form thereof include an electrode constituted only by a molded body made of an electrode mixture, and an electrode in which a layer (electrode mixture layer) formed from a molded body made of the electrode mixture is formed on a current collector.

The molded body made of the electrode mixture includes a composite obtained by compression molding of a mixture containing an active material and a solid electrolyte (A) (composite, which is the molded body (compression molded body) made of the mixture), and a solid electrolyte (B) that is the same as or different from the solid electrolyte (A) and is present between the composites (e.g., granular bodies thereof) in addition to the solid electrolyte (A), and has a porosity of 10% or less and an area of more than 1.8 cm².

A lower limit of the porosity is not limited, and by using highly flexible materials for the solid electrolyte (A) or/and the solid electrolyte (B), the porosity can be made close to 0%.

A method for producing an electrode for an all-solid-state battery according to the present invention includes: a step (a) of forming a composite by applying a pressure of 800 MPa or more to a mixture 1 containing an active material and the solid electrolyte (A); a step (b) of preparing a mixture 2 by mixing the composite with the solid electrolyte (B) that is the same as or different from the solid electrolyte (A); and a step (c) of forming a molded body made of an electrode mixture by forming a layer-like body made of the mixture 2 having a predetermined thickness and an area of more than 1.8 cm² and applying a predetermined pressure of less than 800 MPa to the layer-like body. With this production method, the electrode for an all-solid-state battery according to the present invention can be produced.

In the step (a), a pressure of 800 MPa or more is applied to the mixture 1 containing the solid electrolyte and the active material that constitute the molded body made of the electrode mixture to form a composite. In this case, since the mixture 1 is molded by compression with a size smaller than that of a molded body made of the mixture lastly produced, for example, with an area of, for example, 1.8 cm² or less, to form a composite (molded body), the molded body with a high density (for example, a molded body with a porosity of 8% or less) can be formed by applying a pressure of 800 MPa or more by using a compression molding method using an ordinary device.

However, even if attempts are made to form a molded body made of the electrode mixture and having an area larger than 1.8 cm² by applying pressure to the composite of the mixture 1, which is formed into a molded body as is, or by pulverizing the composition to form granular bodies and then applying pressure to the granular bodies, voids remain between the composites to some extent because the composites have poor fluidity, and thus the density of the molded body made of the electrode mixture cannot be increased using a compression molding method using an ordinary device in which the upper limit of the applicable force is approximately 100 to 200 kN.

In view of this, in the method for producing an electrode for an all-solid-state battery according to the present invention, in the step (b), the mixture 1 formed into the composite through the step (a) (or granular bodies obtained by pulverizing the mixture 1 formed into the composite through the step (a) in a pulverization step described later) and the solid electrolyte (B), which is the same as or different from the solid electrolyte (A) made of the mixture 1 are mixed together to form a mixture 2, which is formed into a layer-like body having a predetermined thickness and an area of more than 1.8 cm² in a step (c), and a predetermined pressure of less than 800 MPa is applied to the layer-like body to form a molded body made of the electrode mixture. In this case, due to effects of the solid electrolyte (B) used together with the mixture 1 that has undergone the step (a), it is possible to increase the density of the molded body made of the electrode mixture and improve ion conductivity to reduce the internal resistance. Thus, with the method for producing an electrode for an all-solid-state battery according to the present invention, a molded body made of an electrode mixture and having an area of more than 1.8 cm² in a plan view can be formed with a high density (e.g., the porosity of the molded body calculated from a true density and a composition ratio of each material included in the molded body made of the electrode mixture, and the mass and the volume of the molded body is 10% or less) without using any special device. Therefore, with the production method of the present invention, it is possible to produce the electrode for an all-solid-state battery according to the present invention having a low internal resistance while increasing the area in a plan view of the molded body made of the electrode mixture as described above.

Hereinafter, the electrode for an all-solid-state battery will be described first, and the each step of the method for producing an electrode for an all-solid-state battery will be described.

Examples of active materials used in electrodes for all-solid-state batteries include the following.

In a case where an electrode for an all-solid-state battery is a positive electrode and is used in an all-solid-state primary battery, it is possible to use, as its active material (positive electrode active material), the same positive electrode active material that is used in conventionally known nonaqueous electrolyte primary batteries. Specifically, examples thereof include manganese dioxide; lithium-containing composite oxides such as lithium-containing manganese oxides (e.g., LiMn₃O₆, composite oxides that have the same crystal structure (β-type structure, γ-type structure, or a structure in which β-type and γ-type are mixed) as manganese dioxide, and contains Li in an amount of 3.5% by mass or less, preferably 2% by mass or less, more preferably 1.5% by mass or less, and particularly preferably 1% by mass or less, or the like), LiₐTi_{5/3}O₄ (4/3≤a<7/3); vanadium oxides; niobium oxides; titanium oxides; sulfides such as iron disulfide; graphite fluoride; silver sulfides such as Ag₂S; and nickel oxides such as NiO₂.

In a case where the electrode for an all-solid-state battery is a positive electrode and is used in an all-solid-state secondary battery, it is possible to use, as its active material (positive electrode active material), the same active material as the positive electrode active material that is used in conventionally known nonaqueous electrolyte secondary batteries, that is, an active material capable of occluding and releasing Li (lithium) ions. Specific examples of the positive electrode active material include spinel-type lithium manganese composite oxides represented by Li₁₋ₓMᵣMn₂₋ᵣO₄ (where M is at least one element selected from the group consisting of Li, Na, K, B, Mg, Ca, Sr, Ba, Ti, V, Cr, Zr, Fe, Co, Ni, Cu, Zn, Al, Sn, Sb, In, Nb, Ta, Mo, W, Y, Ru, and Rh, and x and r satisfy 0≤x≤1 and 0≤r≤1), layered compounds represented by LiᵣMn₍₁₋ₛ₋ₜ₎NiₛMₜO₍₂₋ᵤ₎Fᵥ (where M is at least one element selected from the group consisting of Co, Mg, Al, B, Ti, V, Cr, Fe, Cu, Zn, Zr, Mo, Sn, Ca, Sr, and W, and r, s, t, u, and v satisfy 0≤r≤1.2, 0<s<0.5, 0≤t≤0.5, u+v<1, −0.1≤u≤0.2, and 0≤v≤0.1), lithium cobalt composite oxides represented by Li₁₋ₓCo₁₋ᵣMᵣO₂ (where M is at least one element selected from the group consisting of Al, Mg, Ti, V, Cr, Zr, Fe, Ni, Cu, Zn, Ga, Ge, Nb, Mo, Sn, Sb, Ba, Mn, Bi, Ca, F, P, Sr, W, Si, Ta, K, S, Er, and Na, and x and r satisfy 0≤x≤1 and 0≤r≤0.5), lithium nickel composite oxides represented by Li₁₋ₓNi₁₋ᵣMᵣO₂ (where Mis at least one element selected from the group consisting of Al, Mg, Ti, Zr, Fe, Co, Cu, Zn, Ga, Ge, Nb, Mo, Sn, Sb, and Ba, and x and r satisfy 0≤x≤1 and 0≤r≤0.5), olivine-type composite oxides represented by Li₁₊ₛ₋ₓM₁₋ᵣNᵣPO₄Fₛ (where M is at least one element selected from the group consisting of Fe, Mn, and Co, N is at least one element selected from the group consisting of Al, Mg, Ti, Zr, Ni, Cu, Zn, Ga, Ge, Nb, Mo, Sn, Sb, V, and Ba, and x, r, and s satisfy 0≤x≤1, 0≤r≤0.5, and 0≤s≤1), and pyrophosphate compounds represented by Li₂₋ₓM₁₋ᵣNᵣP₂O₇ (where M is at least one element selected from the group consisting of Fe, Mn, and Co, N is at least one element selected from the group consisting of Al, Mg, Ti, Zr, Ni, Cu, Zn, Ga, Ge, Nb, Mo, Sn, Sb, V, and Ba, and x and r satisfy 0≤x≤2 and 0≤r≤0.5). These compounds may be used alone or in combination of two or more.

In a case where the electrode for an all-solid-state battery is used as a positive electrode of an all-solid-state secondary battery, the average particle size of the positive electrode active material contained therein is preferably 1 μm or more, more preferably 2 μm or more, and preferably 10 μm or less, and more preferably 8 μm or less. Note that the positive electrode active material may be primary particles or secondary particles obtained through aggregation of primary particles. When a positive electrode active material having an average particle size in the above range is used, a large interface with the solid electrolyte contained in the positive electrode can be obtained, thus enhancing output properties of the battery.

The average particle size of various particles (particles of a positive electrode active material, a solid electrolyte, and the like) used in this specification refers to the value of the 50% diameter (D₅₀) in a volume-based integrated fraction when the integrated volume is calculated from particles with a small particle size, using a particle size distribution measuring device (Microtrac particle size analyzer “HRA9320” manufactured by Nikkiso Co., Ltd., etc.).

In a case where the electrode for an all-solid-state battery is a negative electrode and is used in an all-solid-state primary battery, examples of the active material (negative electrode active material) include metallic lithium, lithium alloys (lithium-aluminum alloys, lithium-indium alloys, and the like).

In a case where the electrode for an all-solid-state battery is a negative electrode and is used in an all-solid-state secondary battery, it is possible to use, as its active material (negative electrode active material), any active material that is used in conventionally known lithium secondary batteries without any limitation, as long as the active material is capable of occluding and releasing Li (lithium) ions. For example, one of, or a mixture of two or more of, carbon materials capable of occluding and releasing lithium, such as graphite, pyrolytic carbon, coke, glassy carbon, fired products obtained by firing organic polymer compounds, mesophase carbon microbeads (MCMB), and carbon fibers is used as the negative electrode active material. An oxide may also be used as the negative electrode active material, and examples thereof include composite oxides having a monoclinic crystalline structure represented by LiₓNb_{y}TiM⁶ₐO_{{5y+4/2}+δ} (where M⁶ is at least one selected from the group consisting of V, Cr, Mo, Ta, Zr, Mn, Fe, Mg, B, Al, Cu, and Si, and x, y, δ, and a satisfy 0≤x≤49, 0.5≤y<24, −5≤δ≤5, and 0≤a≤0.3), titanium dioxide having an anatase structure, lithium titanate having a ramsdellite structure represented by Li₂Ti₃O₇, and spinel-type lithium titanium composite oxide represented by Li₄Ti₅O₁₂. These compounds may be used alone or in combination of two or more. Simple substances, compounds, and alloys that include an element such as Si, Sn, Ge, Bi, Sb, or In; compounds that enable charging and discharging at a voltage as low as that in the case of metallic lithium, such as nitrides containing lithium and a transition metal (e.g., Co, Ni, Mn, Fe, Cr, Ti, or W), and lithium-containing oxides; metallic lithium and lithium alloys (lithium-aluminum alloys, lithium-indium alloys, and the like) can also be used as the negative electrode active material.

The active material includes, on its surface, a reaction suppressing layer for suppressing a reaction between the active material and the solid electrolyte. In particular, in a case where the electrode for an all-solid-state battery is a positive electrode, it is preferable that the reaction suppressing layer is provided on the surface of the active material (positive electrode active material).

The reaction suppressing layer is only required to be made of a material that has ion conductivity and can suppress a reaction between the active material and the solid electrolyte. As a material that can constitute the reaction suppressing layer, an oxide that contains Li and at least one element selected from the group consisting of Nb, P, B, Si, Ge, Ti, Zr, Ta, and W can be used. More specific examples include an Nb-containing oxide such as LiNbO₃, as well as Li₃PO₄, Li₃BO₃, Li₄SiO₄, Li₄GeO₄, LiTiO₃, LiZrO₃, Li₂WO₄, and the like. The reaction suppressing layer may contain only one of these oxides, two or more of these oxides, or a composite compound formed by two or more of these oxides. Among these oxides, it is preferable to use an Nb-containing oxide, and more preferably LiNbO₃.

Preferably, 0.1 to 1.0 part by mass of the reaction suppressing layer is present on the surface of the active material (base particles that form the reaction suppressing layer) relative to 100 parts by mass of the active material. When the amount of the reaction suppressing layer is within this range, it is possible to favorably suppress a reaction between the active material and the solid electrolyte.

The reaction suppressing layer can be formed on the surface of the active material using a method such as a sol-gel method, a mechano-fusion method, a CVD method, a PVD method, an ALD method, or the like.

In a case where the electrode for an all-solid-state battery is used as the positive electrode of the all-solid-state battery, the content of the active material in the molded body made of the electrode mixture is preferably 60% by mass to 98% by mass from the viewpoint of further increasing the energy density of the all-solid-state battery.

In a case where the electrode for an all-solid-state battery is used as the negative electrode of the all-solid-state battery, the content of the active material in the molded body made of the electrode mixture is preferably 40% by mass to 99% by mass from the viewpoint of further increasing the energy density of the all-solid-state battery.

There is no particular limitation on the solid electrolyte in the electrode for an all-solid-state battery as long as the solid electrolyte has lithium-ion conductivity, and for example, sulfide-based solid electrolytes, hydride-based solid electrolytes, halide-based solid electrolytes, oxide-based solid electrolytes, and the like can be used.

Examples of the sulfide-based solid electrolytes include particles of Li₂S—P₂S₅-based glass, Li₂S—SiS₂-based glass, Li₂S—P₂S₅—GeS₂-based glass, Li₂S—B₂S₃-based glass or the like. In addition, it is possible to use thio-LISICON-type sulfide-based solid electrolyte (Li_{12-12a-b+c+6d-e}M¹_{3+a-b-c-d}M²_{b}M³_{c}M⁴_{d}M⁵₁₂₋ₑXₑ (where M¹ represents Si, Ge, or Sn, M² represents P or V, M³ represents Al, Ga, Y, or Sb, M⁴ represents Zn, Ca, or Ba, M⁵ represents S or any one of S and O, X represents F, Cl, Br, or I, and a, b, c, d, and e satisfy 0≤a<3, 0≤b+c+d≤3, and 0≤e≤3), such as Li₁₀GeP₂S₁₂ and Li_{9.54}Si_{1.74}P_{1.44}S_{11.7}Cl_{0.3}), and sulfide-based solid electrolyte having an argyrodite-type crystal structure, which have attracted attention in recent years due to their high lithium-ion conductivity.

Examples of the hydride-based solid electrolytes include LiBH₄, and solid solutions of LiBH₄ and a following alkali metal compound (e.g., solid solutions in which the mole ratio between LiBH₄ and the alkali metal compound is 1:1 to 20:1). As the alkali metal compound used in the above-mentioned solid solution, at least one selected from the group consisting of lithium halides (such as LiI, LiBr, LiF, and LiCl), rubidium halides (such as RbI, RbBr, RbF, and RbCl), cesium halides (such as CsI, CsBr, CsF, and CsCl), lithium amides, rubidium amides, and cesium amides can be used.

Examples of the halide-based solid electrolyte include monoclinic LiAlCl₄, defect spinel or layered LiInBr₄, and monoclinic Li₆₋₃ₘYₘX₆ (where m satisfies 0<m<2, and X=Cl or Br). It is also possible to use known solid electrolytes disclosed in WO 2020/070958 and WO 2020/070955.

Examples of the oxide-based solid electrolytes include garnet-type Li₇La₃Zr₂O₁₂, NASICON-type Li_{1+O}Al₁₊₀Ti_{2-O}(PO₄)₃ and Li₁₊ₚAl₁₊ₚGe₂₋ₚ(PO₄)₃, and perovskite-type Li_{3q}La_{2/3-q}TiO₃.

Among these solid electrolytes, sulfide-based solid electrolytes are preferable because sulfide-based solid electrolytes have high lithium-ion conductivity, sulfide-based solid electrolytes containing Li and P are more preferable, and in particular, sulfide-based solid electrolytes having an argyrodite-type crystal structure are even more preferable because such sulfide-based solid electrolytes having an argyrodite-type crystal structure have high lithium-ion conductivity and high chemical stability.

Also, the sulfide-based solid electrolytes are preferably used because they contribute to improving the moldability of the molded body made of the electrode mixture. Note that the electrode for an all-solid-state battery contains, in the molded body made of the electrode mixture, the solid electrolyte (A) that forms a composite with an active material, and a solid electrolyte (B) that is present between the composites, in addition to the solid electrolyte (A). In particular, the solid electrolyte (B) that contributes to the moldability of the molded body made of the electrode mixture is preferably a sulfide-based solid electrolyte having excellent moldability, and both the solid electrolyte (A) and the solid electrolyte (B) are more preferably sulfide-based solid electrolytes.

The sulfide-based solid electrolytes having an argyrodite-type crystal structure represented by General Composition Formula (1) below, General Formula (2) below, or General Composition Formula (3) below, such as Li₆PS₅Cl, are particularly preferable.

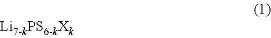

In General Composition Formula (1) above, X represents one or more halogen elements, and k satisfies 0.2<k<2.0 or 0.2<k<1.8.

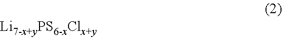

In General Composition Formula (2) above, y satisfies 0.05≤y≤0.9 and −3.0x+1.8≤y≤−3.0x+5.7.

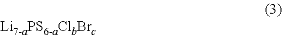

In General Composition Formula (3) above, a, b, and c satisfy a=b+c, 0<a≤1.8, and 0.1≤b/c≤10.0.

From the viewpoint of reducing grain boundary resistance, the average particle size of the solid electrolyte is preferably 0.1 μm or more, and more preferably 0.2 μm or more. On the other hand, from the viewpoint of forming a sufficient contact interface between the active material and the solid electrolyte, the average particle size of the solid electrolyte is preferably 10 μm or less, and more preferably 5 μm or less.

In a case where the electrode for an all-solid-state battery is used as the positive electrode of the all-solid-state battery, from the viewpoint of further increasing ion conductivity in the positive electrode and further improving an output property of the all-solid-state battery, the content of the solid electrolyte in the molded body made of the electrode mixture is preferably 10 parts by mass or more, more preferably 30 parts by mass or more, and particularly preferably 50 parts by mass or more, where the content of the positive electrode active material is 100 parts by mass. However, if the molded body made of the electrode mixture contains an excessive amount of the solid electrolyte, the amount of other components will be reduced, which may reduce effects of the other components. Therefore, the content of the solid electrolyte in the molded body made of the electrode mixture is preferably 90 parts by mass or less, more preferably 80 parts by mass or less, and particularly preferably 70 parts by mass or less, where the content of the positive electrode active material is 100 parts by mass.

In a case where the electrode for an all-solid-state battery is used as the negative electrode in the all-solid-state battery, from the viewpoint of further increasing the ion conductivity in the negative electrode and further improving an output property of the all-solid-state battery, the content of the solid electrolyte in the molded body made of the electrode mixture is preferably 30 parts by mass or more, and more preferably 35 parts by mass or more, where the content of the negative electrode active material is 100 parts by mass. However, if the molded body made of the electrode mixture contains an excessive amount of the solid electrolyte, the amount of other components will be reduced, which may reduce effects of the other components. Therefore, the content of the solid electrolyte in the molded body made of the electrode mixture is preferably 130 parts by mass or less and more preferably 110 parts by mass or less, where the content of the negative electrode active material is 100 parts by mass.

It is possible to add a conductive assistant to the molded body made of the electrode mixture of the electrode for the all-solid-state battery. Examples of such conductive assistants include high-crystallinity carbon materials such as graphite (natural graphite and synthetic graphite), graphene (single-layer graphene and multilayer graphene), and carbon nanotubes; and low-crystallinity carbon materials such as carbon black. These materials may be used alone or in combination of two or more.

In a case where the electrode for an all-solid-state battery is used as the positive electrode of the all-solid-state battery, the content of the conductive assistant in the molded body made of the electrode mixture is preferably 1% by mass to 10% by mass. Further, in a case where the electrode for an all-solid-state battery is used as the negative electrode of the all-solid-state battery, the content of the conductive assistant in the molded body made of the electrode mixture is preferably 5% by mass to 15% by mass.

It is possible to add a binder to the molded body made of the electrode mixture of the electrode for an all-solid-state battery. Specific examples thereof include fluororesins such as polyvinylidene fluoride (PVDF). Note that, for example, in a case where favorable moldability can be ensured when the molded body of the electrode mixture is formed without using a binder as in a case where a sulfide-based solid electrolyte is added to the molded body made of the electrode mixture, a binder does not need to be added to the molded body made of the electrode mixture.

In a case where a binder is required in the molded body made of the electrode mixture, the binder content is preferably 15% by mass or less, and preferably 0.5% by mass or more. On the other hand, in a case where moldability can be obtained in the molded body made of the electrode mixture without the need for a binder, the binder content is preferably 0.5% by mass or less, more preferably 0.3% by mass or less, and even more preferably 0% by mass (i.e., no binder is contained).

The molded body made of the electrode mixture preferably has a thickness of 500 to 3000 μm.

There is no particular limitation on the shape of the molded body made of the electrode mixture, and the shape of the molded body may be a pellet shape (flat plate shape) that is circular or polygonal in a plan view.

It is possible to use a current collector for the electrode for an all-solid-state battery. In a case where the electrode for an all-solid-state battery is used as the positive electrode of the all-solid-state battery, examples of the current collector include foils, punched metals, nets, expanded metals, and foamed metals that are made of a metal such as aluminum or stainless steel; carbon sheets; and the like. Also, in a case where the electrode for an all-solid-state battery is used as the negative electrode of the all-solid-state battery, examples of the current collector include foils, punched metals, nets, expanded metals, and foamed metals that are made of copper or nickel; carbon sheets; and the like. The current collector preferably has a thickness of 30 to 100 μm.

In the step (a) of the method for producing an electrode for an all-solid-state battery, pressure is applied to the mixture 1 containing the active material and the solid electrolyte (A) to convert the mixture 1 to a composite.

There is no particular limitation on the method for preparing the mixture 1, and the active material, the solid electrolyte (A), and the like may be mixed using a known method.

When a conductive assistant or binder is added to the molded body made of the electrode mixture, these can be added when the mixture 1 is prepared. Also, as will be described later, after the step (a), the mixture 1, which has been formed into the composite, is pulverized to form granular bodies with adjusted size. Thereafter, when the mixture 2 is prepared in the step (b), the conductive assistant and the binder may be added during preparation of the mixture 2.

There is no particular limitation on the compression molding means when converting the mixture 1 to a composite, and it is sufficient that any known device capable of compression molding powder is used. The pressure applied is set to 800 MPa or more, more preferably 1000 MPa or more, and more preferably 1200 MPa or more. This increases the density of the composite made of the mixture 1, and this effect and an effect of the solid electrolyte used in the subsequent process are combined together, which increases the density of the molded body made of the electrode mixture obtained lastly, and reducing its internal resistance. Note that the upper limit of pressure applied when converting the mixture 1 to the composite is usually about 2000 MPa.

There is no particular limitation on the shape of the composite made of the mixture (1) obtained through pressure application, and the shape of the composite may be a pellet-like shape (flat plate shape) that is circular or polygonal in a plan view, a spherical shape or the like. The size of the composite made of the mixture 1 is set such that the area in a plan view is, for example, preferably 1.8 cm² or less, more preferably 1.5 cm² or less, and particularly preferably 1 cm² or less, such that the total pressure during pressure application is within a range that can be applied using an ordinary molding device (e.g., up to about 200 kN). On the other hand, in order to improve productivity, the area of the composite in a plan view is preferably 0.1 cm² or more, more preferably 0.2 cm² or more, and particularly preferably 0.5 cm² or more.

Further, there is no particular limitation on the thickness of the composite when the composite is pulverized to adjust its size for use. When the composite is used to form the mixture 2 in a shape obtained at the time of compression molding, it is sufficient that the thickness of the composite is adjusted in consideration of the thickness of the molded body made of the electrode mixture to be produced.

In the step (b) of the method for producing the electrode for an all-solid-state battery, the composite made of the mixture 1 obtained in the step (a) is mixed with the solid electrolyte (B) to prepare a mixture 2.

When preparing the mixture 2, the composite obtained in the step (a) may be used as is as the mixture 1, or a step of pulverizing the composite of the mixture 1 may be carried out prior to the step (b), and the pulverized composite may be used in the form of granular bodies obtained in this step. By using the mixture 2 prepared by pulverizing the composite made of the mixture 1 into granular bodies, the uniformity of the distribution of each component in the obtained molded body made of the electrode mixture is improved, and thus properties of an electrode for an all-solid-state battery and an all-solid-state battery obtained using the electrode are improved.

When the composite made of the mixture 1 is pulverized to form granular bodies, in order to facilitate molding of a molded body made of the electrode mixture with a higher density, the size of the granular bodies is, for example, preferably more than 50 μm, and more preferably more than 100 μm, in terms of an average particle size. On the other hand, in order to set the thickness of the molded body made of the electrode mixture in a suitable range, the average particle size of the granular bodies is appropriately 1 mm or less. The average particle size of the granular bodies used herein refers to D₅₀, which is determined using the same method as the method for measuring the average particle size of the positive electrode active material or the like.

When preparing the mixture 2, it is preferable to adjust the amount of the solid electrolyte (B) to 20 to 60 parts by mass relative to 100 parts by mass of the composite obtained in the step (a). Therefore, it is sufficient that the amount of the solid electrolyte (A) used in the preparation of the mixture 1 in the step (a) is determined in consideration of the amount thereof in the step (b).

Also, as described above, when the mixture 2 is prepared using granular bodies obtained by pulverizing the composite obtained in the step (a), the conductive assistant and the binder may be added to the mixture 2.

There is no particular limitation on the method for preparing the mixture 2, and it is sufficient that various components, to be added to the mixture 2, are mixed using a known method.

In the step (c) of the method for producing the electrode for an all-solid-state battery, the mixture 2 is formed into a layer-like body having a predetermined thickness and an area of more than 1.8 cm², and then pressure is applied to form a molded body made of an electrode mixture.

There is no particular limitation on the compression molding means, and it is sufficient that any known device capable of compression molding of strip-shaped films, powder, or pellets is used. It is sufficient to adjust the pressure to be applied according to the area of the layer-like body made of the mixture 2 such that the total pressure is within a range that can be applied using an ordinary molding device (e.g., up to about 200 kN). For example, when the area of the layer-like body made of the mixture 2 is 5 cm², the pressure can be up to about 400 MPa. This makes it possible to easily increase the density of the molded body made of the electrode mixture, and thus reduce the internal resistance of the electrode for an all-solid-state battery.

In order to increase the density of the molded body made of the electrode mixture, the pressure applied to the layer-like body is preferably 200 MPa or more, and more preferably 300 MPa or more.

The molded body made of the electrode mixture can be used as it is as an electrode for an all-solid-state battery. However, when the molded body made of the electrode mixture is used as an electrode for an all-solid-state battery also having a current collector, for example, in the step (c), pressure can be applied to the mixture 2 on the current collector to form the molded body made of the electrode mixture.

A solid electrolyte layer may be prepared in advance, and then a molded body made of the electrode mixture may be formed on the solid electrolyte layer in the step (c), thus bonding the solid electrolyte layer and the electrode for an all-solid-state battery together. Further, by forming a molded body made of a positive electrode mixture (or a molded body made of a negative electrode mixture) on one surface of the solid electrolyte layer through the step (c) and further forming a molded body made of a negative electrode mixture (or a molded body made of a positive electrode mixture) on the other surface of the solid electrolyte layer through the step (c), it is also possible to obtain a power generating element in which electrodes for all-solid-state batteries are formed on both surfaces of the solid electrolyte layer.

There is no particular limitation on the area in a plan view of the molded body made of an electrode mixture in the electrode for an all-solid-state battery obtained using the production method according to the present invention, as long as the area is larger than 1.8 cm². When an ordinary hydraulic pressing machine or mold is used, it is possible to form an electrode with an area similar to that of conventionally used electrodes (e.g., about 3 cm² in the case of coin-type batteries). By performing compression molding using a roll press or the like, it is possible to enlarge the area to 10 cm² or more, making it possible to use the electrode in batteries that require a larger electrode area. Even in such cases, the electrode for an all-solid-state battery having a low internal resistance and favorable properties can be obtained.

### <All-Solid-State Battery>

The all-solid-state battery according to the present invention is formed by sealing, in an exterior body, a power generating element in which a positive electrode having a molded body made of a positive electrode mixture, a solid electrolyte layer, and a negative electrode having a molded body made of a negative electrode mixture are stacked, and at least one of the positive electrode and the negative electrode is the electrode for an all-solid-state battery according to the present invention.

That is, in the all-solid-state battery of the present invention, since at least one of the positive electrode and the negative electrode is an electrode for an all-solid-state battery having a lower internal resistance, the internal resistance is reduced.

In the all-solid-state battery according to the present invention, it is sufficient that only one of the positive electrode and the negative electrode is the electrode for an all-solid-state battery according to the present invention, but it is preferable that both the positive electrode and the negative electrode are the electrodes for an all-solid-state battery according to the present invention.

In the all-solid-state battery, when only the positive electrode is the electrode for an all-solid-state battery according to the present invention, the negative electrode may be, for example, a negative electrode having a molded body made of a negative electrode mixture obtained by molding the negative electrode mixture obtained by mixing constituent materials such as a negative electrode active material and a solid electrolyte in the same manner as in the step (c) without the steps (a) and (b); a negative electrode consisting of a foil of various alloys (lithium alloys such as lithium-aluminum alloys and lithium-indium alloys) or metallic lithium that function as a negative electrode active material, or a negative electrode in which the foils are stacked as active material layers on a current collector; or the like.

In the all-solid-state battery, when only the negative electrode is the electrode for an all-solid-state battery according to the present invention, the positive electrode may be, for example, a positive electrode having a molded body made of a positive electrode mixture obtained by molding the positive electrode mixture obtained by mixing constituent materials such as a positive electrode active material and a solid electrolyte in the same manner as in the step (c) without the steps (a) and (b), or the like.

Specific examples of the solid electrolyte that constitutes the solid electrolyte layer in a power generating element according to the all-solid-state battery are the same as the solid electrolytes listed above as examples of the solid electrolyte that can be used in the electrodes for all-solid-state batteries. Among the solid electrolytes listed above, due to having high lithium-ion conductivity and also functioning to improve moldability, it is preferable to use sulfide-based solid electrolytes, and it is more preferable to use sulfide-based solid electrolytes having an argyrodite-type crystal structure, and it is even more preferable to use sulfide-based solid electrolytes represented by General Composition Formula (1) above, General Composition Formula (2) above, or General Composition Formula (3) above.

The solid electrolyte layer may include a porous body such as a resin non-woven fabric as a support.

The thickness of the solid electrolyte layer is preferably 10 to 200 μm.

The all-solid-state battery is produced by producing at least one of the positive electrode and the negative electrode using the method for producing an electrode for an all-solid-state battery according to the present invention to form a power generating element and sealing the power generating element in an exterior body.

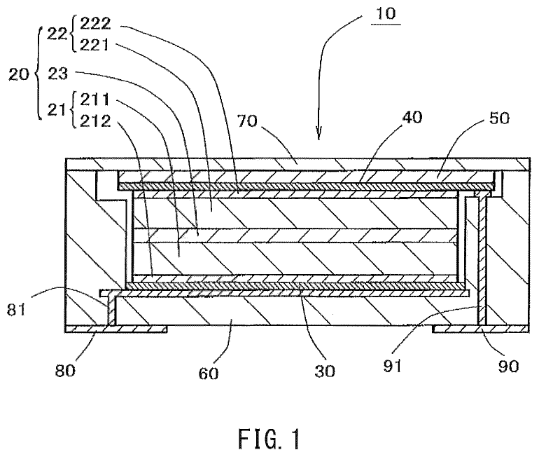

FIG. 1 is a schematic longitudinal cross-sectional view showing an example of the all-solid-state battery of the present invention. An all-solid-state battery 10 shown in FIG. 1 includes a power generating element 20 having a positive electrode 21, a negative electrode 22, and a solid electrolyte layer 23 interposed between the positive electrode 21 and the negative electrode 22, and has a configuration in which the power generating element 20 is sealed in an exterior body formed by an exterior container 60 and a lid 70.

A lower surface of the exterior container 60 in FIG. 1 has external terminals 80 and 90, for electrical connection to a device in which the all-solid-state battery 10 is used. The external terminal 80 is electrically connected to the positive electrode 21 of the power generating element 20 through a conductive path 81. The external terminal 90 is electrically connected to the negative electrode 22 of the power generating element 20 through a lead 40 and a conductive path 91.

The positive electrode 21 that constitutes the power generating element 20 has a positive electrode mixture layer (a molded body made of the positive electrode mixture) 211 and a current collector 212. Further, the negative electrode 22 that constitutes the power generating element 20 has a negative electrode mixture layer (a molded body made of the negative electrode mixture) 221 and a current collector 222.

A conductive sheet (a metal foil, a porous metal foam, or the like) 30 is disposed on a surface of the current collector 212 of the positive electrode 21 (a surface opposite to the positive electrode mixture layer 211). The current collector 212 is brought into contact with the positive electrode 21, thus providing electrical conduction between the positive electrode 21 and the conductive sheet 30, and electrical conduction between the conductive sheet 30 and the conductive path 81.

In the all-solid-state battery 10 shown in FIG. 1, a spacer 50 that functions to press the power generating element 20 toward the conductive sheet 30 side is disposed between the lead 40 and the lid 70, and the function of the spacer 50 improve electrical connection between the lead 40 and the negative electrode 22 and between the lead and the conductive path 91, electrical connection between the positive electrode 21 and the conductive sheet 30, and electrical connection between the conductive sheet 30 and the conductive path 81.

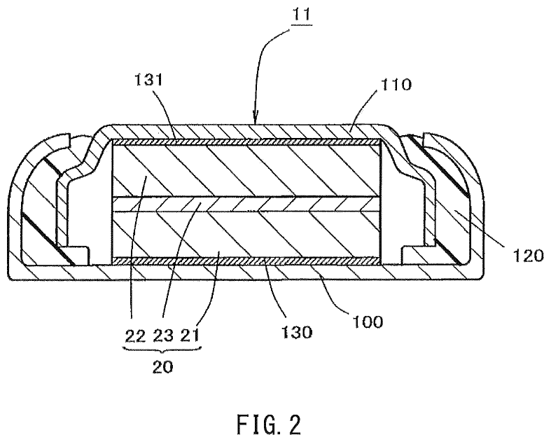

FIG. 2 is a schematic longitudinal cross-sectional view showing another example of the all-solid-state battery of the present invention. In an all-solid-state battery 11 shown in FIG. 2, a power generating element 20 in which a positive electrode 21, a solid electrolyte layer 23, and a negative electrode 22 are stacked are enclosed in the exterior body formed of an exterior can 100, a sealing can 110, and a resin gasket 120 provided between the exterior can 100 and the sealing can 110.

The sealing can 110 is fitted to an opening of the exterior can 100 via the gasket 120, and an opening end of the exterior can 100 is squeezed inward, thereby causing the gasket 120 to abut against the sealing can 110. In this way, the opening of the exterior can 100 is sealed, and thus the inside of the battery has a hermetically sealed structure.

A current collector 130 is interposed between the positive electrode 21 and the exterior can 100, and an inner surface of the exterior can 100 is electrically connected to the positive electrode 21 via the current collector 130, and thus the exterior can 100 serves as a positive electrode terminal. A current collector 131 is interposed between the negative electrode 22 and the sealing can 110, and an inner surface of the sealing can 110 is electrically connected to the negative electrode 22 via the current collector 131, and thus the sealing can 110 serves as a negative electrode terminal. Note that, depending on applications of the battery and the like, the exterior can also serve as the negative electrode terminal, and the sealing can also serve as the positive electrode terminal.

As shown in FIG. 2, in the all-solid-state battery, it is also possible to use a current collector for the positive electrode that is separate from the positive electrode, and a current collector for the negative electrode that is separate from the negative electrode. Further, the positive electrode and the negative electrode may be in direct contact with the inner surface of the exterior can and the inner surface of the sealing can without a current collector.

The power generating element can be produced by bonding the positive electrode, the solid electrolyte layer, and the negative electrode together, for example. In this case, for example, the power generating element can be produced by first compression molding of a solid electrolyte to form the solid electrolyte layer, providing the electrode for an all-solid-state battery of the present invention (positive electrode or negative electrode) on one surface of the solid electrolyte layer, and further providing the electrode for an all-solid-state battery of the present invention (negative electrode or positive electrode) on the other surface of the solid electrolyte layer, or attaching an electrode (negative electrode or positive electrode) other than the electrode for an all-solid-state battery of the present invention. When providing the electrode for an all-solid-state battery of the present invention on the solid electrolyte layer, a method for bonding an electrode for an all-solid-state battery that has been separately produced to a solid electrolyte layer or the like can be adopted. However, as described above, the electrode for an all-solid-state battery can also be produced directly on the solid electrolyte layer.

The obtained power generating element is then sealed in the exterior body to obtain the all-solid-state battery. It is possible to use, as the exterior body of the all-solid-state battery, a battery container having an exterior container and a lid as shown in FIG. 1; a flat (coin-shaped, button-shaped, or the like) battery container having an exterior can and a sealing can as shown in FIG. 2; a sheet-shaped battery container constituted by a resin film or a resin-metal laminate film; or the like.

In the case of a battery container having an exterior container and a lid as shown in FIG. 1, it is possible to use an exterior container made of a ceramic material or resin. Also, it is possible to use a lid made of a ceramic material, resin, or metal (an iron-based alloy such as an iron-nickel alloy or an iron-nickel-cobalt alloy, or the like). In the exterior container, the external terminal and the conductive path that connects an electrode according to the electrode stacked body and the external terminal can be made of metal such as manganese, cobalt, nickel, copper, molybdenum, silver, palladium, tungsten, platinum, or gold, or an alloy containing such a metal, or the like.

The exterior container and the lid can be sealed by bonding them together with an adhesive, or when a metal lid is used, the lid side of a side wall of a recess of the exterior container may be made of metal (an iron-based alloy such as an iron-nickel alloy or an iron-nickel-cobalt alloy, or the like) and then sealed by welding the exterior container and the lid together.

In the case of a battery container having an exterior can and a sealing can as shown in FIG. 2, stainless steel cans or the like can be used as the exterior can and the sealing can. The exterior can and the sealing can are able to be sealed using a resin adhesive or by crimping them with a gasket interposed therebetween. As the material of the gasket, polypropylene, nylon, or the like can be used. Other than these, in a case where heat resistance is required depending on the application of the battery, it is also possible to use a heat resistant resin that has a melting point of greater than 240° C. such as: a fluororesin such as a tetrafluoroethylene-perfluoroalkoxy ethylene copolymer (PFA); polyphenylene ether (PPE); polysulfone (PSF); polyarylate (PAR); polyether sulfone (PES); polyphenylene sulfide (PPS); or polyetheretherketone (PEEK). In a case where the battery is used in applications where heat resistance is required, a glass hermetic seal can also be used for sealing.

### EXAMPLES

Hereinafter, the present invention will be described in detail based on examples. However, the examples given below do not limit the scope of the present invention.

### Example 1

### <Production of Positive Electrode>

A mixture 1 was obtained by mixing 83 parts by mass of LiCo_{0.98}Al_{0.01}Mg_{0.01}O₂ (positive electrode active material) particles having an average particle size of 5 μm and having LiNbO₃ coating layers formed on their surfaces, 14 parts by mass of sulfide-based solid electrolyte (Li_{5.8}PS_{4.4}Cl_{1.2}) particles having an average particle size of 0.7 μm, and 3 parts by mass of graphene (conductive assistant) having an average particle size of 8 μm, a thickness of 10 to 20 nm, and a BET specific surface area of 24 m²/g.

Then, the mixture 1 was placed in a powder molding mold, compression molding was performed using a pressing machine at a surface pressure of 1400 MPa (total pressure was 110 kN, which was the upper limit of the pressing machine used) to produce a composite that was circular in a plan view (diameter: 1 cm, area: 0.79 cm², porosity: 4%).

Further, the composite was pulverized to form granular bodies having an average particle size of about 300 μm, and then 65 parts by mass of the granular bodies, 32 parts by mass of the same sulfide-based solid electrolyte as above, and 3 parts by mass of the same graphene as above were mixed together to obtain a mixture 2.

Then, the mixture 2 was placed in a powder molding mold, compression molding was performed using the same pressing machine as above at a surface pressure of 350 MPa (total pressure was 110 kN, which was the upper limit of the pressing machine used) to produce a positive electrode constituted by the molded body made of the positive electrode mixture that was circular in a plan view (diameter: 2 cm, area: 3.14 cm², thickness: 0.96 mm, porosity: 7%). The ratio of the positive electrode active material, the solid electrolyte, and the conductive assistant contained in the entire positive electrode mixture was 54:41:5 (mass ratio).

### <Assembly of Battery>

A negative electrode mixture was prepared by mixing lithium titanate (Li₄Ti₅O₁₂, negative electrode active material) particles having an average particle size of 2 μm, the same sulfide-based solid electrolyte as that used in the positive electrode, and the same graphene (conductive assistant) as that used in the positive electrode in a mass ratio of 50:41:9.

A temporarily molded layer for the solid electrolyte layer was formed by placing the same sulfide-based solid electrolyte as that used in the positive electrode on a molded body, which was to be the positive electrode, in the powder molding mold, and performing compression molding at a surface pressure of 70 MPa using a pressing machine. Further, the negative electrode mixture was placed on an upper face of the temporarily molded layer for the solid electrolyte layer and subjected to compression molding at a surface pressure of 50 MPa, and then a temporarily molded layer for the negative electrode was further formed on the temporarily molded layer for the solid electrolyte layer. Thereafter, the entirety was subjected to compression molding at a surface pressure of 350 MPa (the total pressure was 110 kN, which was the upper limit of the pressing machine used), to produce a power generating element in which the positive electrode, the solid electrolyte layer with a thickness of 0.1 mm, and the negative electrode constituted by the molded body with a thickness of 1.4 mm.

A flexible graphite sheet “PERMA-FOIL (product name)” (the thickness: 0.1 mm, apparent density: 1.1 g/cm³) manufactured by Toyo Tanso Co., Ltd. was punched into two sheets of the same size as that of the power generating element. One of the two obtained graphite sheets was placed on the inner bottom of a stainless steel sealing can in which a polypropylene annular gasket was fitted, and then the power generating element was placed thereon with the negative electrode being on the graphite sheet side. Furthermore, the remaining graphite sheet was placed on the positive electrode of the molded body, and a stainless steel exterior can was placed over it. The opening end of the exterior can was then crimped inward to seal the can, thereby producing an all-solid-state secondary battery (coin-shaped all-solid-state secondary battery) having a structure shown in FIG. 2.

### Example 2

A mixture 2 was produced in the same manner as in Example 1, except that the composite made of the mixture 1 was pulverized to form granular bodies having an average particle size of about 30 μm. A coin-shaped all-solid-state secondary battery was produced in the same manner as in Example 1, except that the positive electrode constituted by the molded body (diameter: 2 cm, area: 3.14 cm², thickness: 0.98 mm, porosity: 9%) made of the positive electrode mixture was produced using the mixture 2.

### Comparative Example 1

The same positive electrode active material, solid electrolyte, conductive assistant as those used in Example 1 were mixed in a ratio (mass ratio) of 54:41:5 to prepare a positive electrode mixture. Then, the positive electrode mixture was placed in a powder molding mold, compression molding was performed using the pressing machine at a surface pressure of 350 MPa (total pressure was 110 kN, which was the upper limit of the pressing machine used) to produce a positive electrode constituted by the molded body made of the positive electrode mixture that was circular in a plan view (diameter: 2 cm, area: 3.14 cm², thickness: 0.96 mm, porosity: 17%).

Then, a coin-shaped all-solid-state secondary battery was produced in the same manner as in Example 1, except that a power generating element was produced using the positive electrode.

### Comparative Example 2

The same positive electrode active material, solid electrolyte, conductive assistant as those used in Example 1 were mixed in a ratio (mass ratio) of 54:41:5 to prepare the mixture 1.

Then, the mixture 1 was placed in a powder molding mold, compression molding was performed using a pressing machine at a surface pressure of 1400 MPa (total pressure was 110 kN, which was the upper limit of the pressing machine used) to produce a composite that was circular in a plan view (diameter: 1 cm, porosity: 5%).

Then, the composite was pulverized to form granular bodies having an average particle size of about 30 μm, the granular bodies were placed in a powder molding mold, compression molding was performed using a pressing machine at a surface pressure of 350 MPa (total pressure was 110 kN, which was the upper limit of the pressing machine used) to produce a positive electrode constituted by the molded body made of the positive electrode mixture that was circular in a plan view (diameter: 2 cm, area: 3.14 cm², thickness: 0.96 mm, porosity: 12%).

Then, a coin-shaped all-solid-state secondary battery was produced in the same manner as in Example 1, except that a power generating element was produced using the positive electrode.

### [Evaluation of Internal Resistance]

Each of ten all-solid-state secondary batteries of the examples and comparative examples was subjected to constant current-constant voltage charging, which was a combination of constant current charging at a current value of 0.5 C to a battery voltage of 2.6 V, and constant voltage charging at a voltage of 2.6 V to a current value of 0.01 C, and thereafter, a chemical conversion treatment was performed in which constant current discharging was performed at a current value of 0.05 C to a battery voltage of 1.0 V. An alternating current of 1 kHz was applied to each battery obtained after the chemical conversion treatment, the internal resistance of the battery was measured, and the average value of the internal resistance of the ten batteries was calculated. The results are shown in Table 1 using relative values, where the internal resistance of the battery of Example 1 was set to 100.

Since the batteries of the examples and the comparative examples had the same negative electrode and the same solid electrolyte layer, it is conceivable that a difference in the internal resistance of the batteries directly reflects the difference in the internal resistance of the positive electrodes. Therefore, the internal resistance of the positive electrode can be evaluated using the internal resistance of the battery obtained through this measurement.

TABLE 1

| | Internal Resistance of Battery |
|---|---|
| Example 1 | 100 |
| Example 2 | 118 |
| Comparative Example 1 | 260 |
| Comparative Example 2 | 176 |

From the results shown in Table 1, the all-solid-state secondary batteries of Examples 1 and 2, in which a pressure of 800 MPa or more was once applied to the mixture containing an active material and a solid electrolyte to form a high-density composite, and the obtained composite was mixed with the solid electrolyte to form a positive electrode mixture, had a lower internal resistance than the all-solid-state second battery of Comparative Example 1, in which the positive electrode mixture was formed without forming the composite, and the all-solid-state secondary battery of Comparative Example 2, in which the positive electrode mixture was formed only using the composite without mixing the composite with the solid electrolyte even when the composite was formed. Therefore, the internal resistance of the positive electrode was able to be reduced.

The invention may be embodied in other forms without departing from the essential characteristics thereof. The embodiments disclosed in this application are to be considered in all respects as illustrative and not limiting. The scope of the present invention should be construed in view of the appended claims, rather than the foregoing description, and all changes that come within the meaning and range of equivalency of the claims are intended to be embraced therein.

### INDUSTRIAL APPLICABILITY

The all-solid-state battery of the present invention can be used for the same applications as conventionally known all-solid-state batteries (all-solid-state primary batteries or all-solid-state batteries). Also, the electrode for an all-solid-state battery of the present invention can constitute the all-solid-state battery of the present invention.

### DESCRIPTION OF REFERENCE NUMERALS

10, 11 All-solid-state battery
20 Power generating element
21 Positive electrode
211 Positive electrode mixture layer (molded body made of positive electrode mixture)
212 Current collector
22 Negative electrode
221 Negative electrode mixture layer (molded body made of negative electrode mixture)
222 Current collector
23 Solid electrolyte layer
30 Conductive sheet
40 Lead
50 Spacer
80, 90 External terminal
81, 91 Conductive path
100 Exterior can
110 Sealing can
120 Gasket
130, 131 Current collector

1. An electrode for an all-solid-state battery, comprising:
a molded body made of an electrode mixture, the electrode mixture containing a composite, which is obtained by compression molding of a mixture containing an active material and a solid electrolyte (A), and a solid electrolyte (B) that is the same as or different from the solid electrolyte (A),
wherein the molded body made of the electrode mixture has a porosity of 10% or less and an area of more than 1.8 cm².

2. The electrode for an all-solid-state battery according to claim 1,
wherein the composite includes granular bodies having an average particle size of more than 50 μm.

3. The electrode for an all-solid-state battery according to claim 1,
wherein the solid electrolyte (A) and the solid electrolyte (B) are each a sulfide-based solid electrolyte.

4. A method for producing the electrode for an all-solid-state battery according to claim 1, comprising:
a step (a) of forming the composite by applying a pressure of 800 MPa or more to a mixture 1 containing the active material and the solid electrolyte (A);
a step (b) of preparing a mixture 2 by mixing the composite and the solid electrolyte (B) that is the same as or different from the solid electrolyte (A); and
a step (c) of forming the molded body made of the electrode mixture by forming a layer-like body made of the mixture 2 having a predetermined thickness and an area of more than 1.8 cm² and applying a predetermined pressure of less than 800 MPa to the layer-like body.

5. The method for producing the electrode for an all-solid-state battery according to claim 4, further comprising
a step of adjusting a size of the composite by pulverizing the composite, between the step (a) and the step (b).

6. The method for producing the electrode for an all-solid-state battery according to claim 4,
wherein the solid electrolyte (A) and the solid electrolyte (B) are each a sulfide-based solid electrolyte.

7. An all-solid-state battery formed by sealing, in an exterior body, a power generating element in which a positive electrode having a molded body made of a positive electrode mixture, a solid electrolyte layer, and a negative electrode having a molded body made of a negative electrode mixture are stacked,
at least one of the positive electrode and the negative electrode being the electrode for an all-solid-state battery according to claim 1.

8. The all-solid-state battery according to claim 7,
wherein at least one of the molded body made of the positive electrode mixture, the solid electrolyte layer, and the molded body made of the negative electrode mixture contains a sulfide-based solid electrolyte.
